(19) United States
(12) Patent Application Publication
(10) Pub. No.: US 2023/0032140 A1
(43) Pub. Date: Feb. 2, 2023

(54) METHODS OF INCREASED CONTACT LENS ROTATION AND RELATED CONTACT LENSES

(71) Applicant: CooperVision International Limited, Fareham (GB)

(72) Inventors: Paul CHAMBERLAIN, Livermore, CA (US); Martin WEBBER, Southampton (GB); Baskar ARUMUGAM, Dublin, CA (US); Arthur BRADLEY, Bloomington, IN (US)

(73) Assignee: CooperVision International Limited, Fareham (GB)

(21) Appl. No.: 17/869,802

(22) Filed: Jul. 21, 2022

Related U.S. Application Data
(60) Provisional application No. 63/226,223, filed on Jul. 28, 2021.

(51) Int. Cl. G02C 7/04; G02B 1/04

(52) U.S. Cl. CPC G02C 7/041; G02B 1/043; G02C 2202/24

(57) ABSTRACT

A contact lens that is configured to rotate when the lens is being worn by a lens wearer, methods of manufacturing such a lens, and methods of using such a lens to provide a rotationally varying treatment to a lens wearer are described. The lens includes an optic zone and a peripheral zone surrounding the optic zone. The peripheral zone has a variation in thickness configured to promote rotation of the lens.

This application claims the benefit under 35 U.S.C. § 119(e) of prior U.S. Provisional Patent Application No. 63/226,223, filed Jul. 28, 2021, which is incorporated in its entirety by reference herein.

The present disclosure concerns contact lenses that have a peripheral zone thickness variation that is configured to promote rotation of the lens when the lens is being worn by a lens wearer. The present disclosure also concerns methods of manufacturing such lenses and methods of using such lenses.

### BACKGROUND

Contact lenses, i.e. ophthalmic lenses that can be placed on the surface of the eye, are typically designed to rest on the lens wearer's cornea, and are generally designed to provide clinically acceptable levels of on-eye movement and not bind to the eye of the wearer. Such lenses may be soft contact lenses, such as hydrogel, or silicone hydrogel contact lenses. Contact lenses may be designed to have different focusing or refractive powers along different meridians, such that different regions of the lens wearer's retina will be subject to different focusing or refractive powers when the lens is being worn by the wearer. For example, toric contact lenses are designed to have different refractive or focusing powers along mutually orthogonal axes

For lenses that are designed to provide different focusing or refractive powers along different meridians, it is important to maintain a specific orientation of the lens relative to the lens wearer's eye when the lens is being worn, and it is therefore important to control rotation of the lens relative to a lens wearer's eye, about an optical axis.

In known contact lenses, for example, in toric lenses, a peripheral zone may provide ballasting to prevent rotation of the lens about the optical axis when the lens is worn by a wearer. Typically, the peripheral zone is not part of the optic zone, but sits outside the optic zone and above the iris when the lens is worn, and it provides mechanical functions, for example, increasing the size of the lens thereby making the lens easier to handle, and/or providing a shaped region that improves comfort for the lens wearer, in addition to providing ballasting to prevent rotation of the lens. The ballasting may be provided by a periballast, a prism ballast, or a dynamic stabilisation feature (such as two thin zones provided along a vertical meridian separating the superior and inferior halves).

The present invention seeks to provide a method of rotating a lens to provide a variable treatment to different regions of the retina.

### SUMMARY

The present disclosure provides, according to a first aspect, a contact lens comprising an optic zone and a peripheral zone surrounding the optic zone. The peripheral zone has a variation in thickness configured to promote rotation of the lens.

The present disclosure provides, according to a second aspect, a method of manufacturing a contact lens. The method comprises forming a contact lens, the lens including an optic zone and a peripheral zone surrounding the optic zone. The peripheral zone has a thickness variation configured to promote rotation of the lens.

The present disclosure provides, according to a third aspect, a method of providing rotationally varying treatment targeted at a region of a lens wearer's retina. The method comprises providing a contact lens according to a first aspect to a lens wearer.

It will of course be appreciated that features described in relation to one aspect of the present disclosure may be incorporated into other aspects of the present disclosure. For example, the method of the disclosure may incorporate features described with reference to the apparatus of the disclosure and vice versa.

### DESCRIPTION OF THE DRAWINGS

FIG. 1 is a schematic diagram showing visual fields of the eye divided into quadrants;

FIG. 2A is a schematic top view of a lens with a peripheral zone having seed-shaped ballasts according to an embodiment of the present disclosure;

FIG. 2B is a schematic cross section view along the line Y-Y of one of the seed-shaped ballasts of FIG. 2A;

FIG. 3A is a schematic top view of a lens with a peripheral zone having prism-shaped ballasts according to an embodiment of the present disclosure;

FIG. 3B is a schematic cross section view along the line Y-Y of one of the prism-shaped ballasts of FIG. 3A;

FIG. 4A is a schematic top view of a lens with a peripheral zone comprising a continuous ring that provides a varying thickness profile, according to an embodiment of the present disclosure;

FIG. 4B is a schematic plot of the variation in thickness of the continuous ring of FIG. 4A around a portion of the peripheral zone;

FIG. 5A is a schematic top view of a lens with a peripheral zone having ballasts that vary in thickness in a radial direction according to an embodiment of the present disclosure;

FIG. 5B is a schematic cross section taken the line X-X of one of the ballasts of FIG. 5A;

FIG. 5C is a schematic cross section taken the line Y-Y of one of the ballasts of FIG. 5A;

FIG. 6A is a schematic top view of a lens with a peripheral zone comprising a plurality of concentric zones, each concentric zone having seed-shaped ballasts according to an embodiment of the present disclosure;

FIG. 6B is a schematic cross section view taken through one of the seed-shaped ballasts of FIG. 6A;

FIG. 7 is a schematic top view of a lens with an annular region that comprises a plurality of treatment zones, according to an embodiment of the present disclosure;

FIG. 8 is a schematic top view of a lens with a peripheral zone comprising a plurality of treatment zones that include scattering elements, according to an embodiment of the present disclosure;

FIG. 9A is a schematic top view of a lens with a peripheral zone comprising a plurality of treatment zones that have a curvature providing an add power, according to an embodiment of the present disclosure;

FIG. 9B is a schematic ray diagram for the optic zone of the lens of FIG. 9A, taken along the line A-A;

FIG. 10A is a schematic top view of a lens with a peripheral zone comprising a plurality of treatment zones that have a curvature providing an add power, wherein the centre of curvature of the treatment zones is offset from the first optical axis, according to an embodiment of the present disclosure;

FIG. 10B is a schematic partial ray diagram for the optic zone of the lens of FIG. 10A, taken along the line B-B showing the radii of curvature of the central zone and the treatment zones; and

FIG. 10C is a further schematic ray diagram for the optic zone of the lens of FIG. 10A, taken along the line B-B.

### DETAILED DESCRIPTION

The present disclosure provides, according to a first aspect, a contact lens comprising an optic zone and a peripheral zone surrounding the optic zone. The optic zone has a variation in thickness configured to promote rotation of the lens.

As used herein, the term contact lens refers to an ophthalmic lens that can be placed onto the anterior surface of the eye. It will be appreciated that such a contact lens will provide clinically acceptable on-eye movement and not bind to the eye or eyes of a person. The contact lens may be in the form of a corneal lens (e.g., a lens that rests on the cornea of the eye). The contact lens may be a soft contact lens, such as a hydrogel contact lens or a silicone hydrogel contact lens.

A contact lens according to the present disclosure comprises an optic zone. The optic zone encompasses parts of the lens that have optical functionality. The optic zone is configured to be positioned over the pupil of an eye when in use.

The optic zone is surrounded by a peripheral zone. An edge zone may surround the peripheral zone. The peripheral zone is not part of the optic zone, but sits outside the optic zone and above the iris when the lens is worn, and it provides mechanical functions, for example, increasing the size of the lens thereby making the lens easier to handle, or providing a shaped region that improves comfort for the lens wearer. The peripheral zone may extend to the edge of the contact lens. In known contact lenses, for example, in toric lenses, the peripheral zone may provide ballasting to prevent rotation of the lens about the optical axis when the lens is worn by a wearer. The present disclosure relates to a contact lens that is designed to rotate on the eye, and in embodiments of the present disclosure, the peripheral zone has a thickness profile that is configured to promote rotation of the lens. The thickness profile may either vary along a meridian, or may be constant along a meridian. The thickness of the peripheral zone may vary with meridian. The thickness profile variation may result from features disposed on a surface of the peripheral zone. The features may be designed to promote rotation of the lens in one direction about the optical axis in response to a rotational force. When contact lenses according to embodiments of the present disclosure are being worn, the rotational force may be provided by a wearer blinking. Rotation of the lens may also be assisted by gravitational forces acting upon the lens.

As the lens of the present disclosure is designed to rotate on the eye when worn by a wearer, the treatment portion will rotate relative to the eye when the lens is being worn. The treatment portion will therefore coincide with different regions of the retina at different times whilst the lens is being worn. This is believed to reduce the ability of the eye to compensate for the effects of the treatment portion and/or may enable different regions of the retina to be targeted with a treatment zone at different times.

Optionally, the thickness profile of the peripheral zone has no axis of mirror symmetry. For example, the thickness profile of the peripheral zone may be rotationally asymmetric. The thickness variation of the peripheral zone may vary in an aperiodic or irregular manner around all or part of the lens. One meridian, which may span less than half of the lens circumference, or more than half of the lens circumference, may have a thicker peripheral zone profile than the remainder of the peripheral zone. The thickness of various regions of the peripheral zone can be selected using routine methods known to persons of ordinary skill in the art. Thicknesses and configurations can be selected to achieve any desired amount of contact lens rotation on the eye without significantly decreasing contact lens comfort or without increasing lens awareness. For example, in the design of the peripheral zone, a contact lens can be manufactured with a particular target design and thickness and clinically tested on an eye of a person. The amount of lens rotation can be observed by an eye care practitioner using a slit lamp or other conventional tool. Typically, multiple contact lenses with different thickness profiles will be manufactured and tested on-eye of many people (e.g., 20 or more) to assess lens rotation and lens comfort. If the lens rotation is too little or too great, or if lens comfort is significantly reduced compared to a control lens, then a lens with a different thickness profile in the peripheral zone is manufactured and tested.

The thickness profile of the peripheral zone may be constant on one half of the lens and may vary on the other half of the lens. Half of the lens may have a peripheral zone thickness that varies in an irregular or aperiodic manner. The variation on the other half of the lens may provide a prism ballast on that half of the lens.

The thickness of the peripheral zone may vary periodically around the lens. The peripheral zone may comprise a plurality features that alter the thickness of the peripheral region. These features may be spaced at regular intervals around the lens. Each feature may have an asymmetric profile that promotes rotation of the lens in one direction. The features may be aligned such that the non-rotational force of blinking is translated into a rotational force, such that the lens rotates in one direction. The features may be disposed on a surface of the peripheral zone.

The periodic variation may be a sinusoid waveform, triangular waveform, or sawtooth waveform. The periodic variation may span a portion of the circumference of the peripheral zone, or the entire circumference of the peripheral zone.

The optic zone may include a central region and an annular region that surrounds the central region. An annular region may comprise a treatment portion that varies with meridian. A treatment portion may span a sector of the annular region. A treatment portion may be a continuous portion. A treatment portion may span less than 50% of the area of the annular region. A treatment portion may span less than 25% of the annular region. An annular region may comprise a plurality of treatment portions. A blending region may be provided between a central region and an annular region. A blending region may be provided between an annular region and a treatment portion. Any blending regions should not substantially affect the optics provided by the optic zone, a central zone, an annular region and/or a treatment portion. Any blending regions may have a radial width of 0.05 mm or less, although it may also be as wide as 0.2 mm, or as wide as 0.5 mm in some embodiments.

The optic zone has a base power, which in the context of the present disclosure, is defined as the average absolute refractive power of the central region. Any base power meridians will also have the base power. The base power will correspond to the labelled refractive power of the contact lens as provided on the contact lens packaging (though in practice it may not have the same value). Thus, the lens powers given herein are nominal powers. These values may differ from lens power values obtained by direct measurement of the lens, and are reflective of the lens powers that are used to provide a required prescription power when used in ophthalmic treatment.

For lenses used in the treatment of myopia, the base power will be negative or close to zero, and a central region will correct for distance vision. The base power of the optic zone may be between 0.5 diopters (D) and −15.0 diopters. The base power may be from −0.25 D to −15.0 D.

Lenses according to embodiments of the present disclosure may be lenses for use in the management of myopia, such as for slowing the progression of myopia. Alternatively, lenses according to embodiments of the present disclosure may be lenses for use in supplying and distributing beneficial agents or other substances to a lens wearer's retina. For example, they may be useful in delivering comfort agents, wetting agents, and the like to the eye of a person. Alternatively, lenses according to embodiments of the present disclosure may be lenses for use generating rotationally varying lens features for aesthetic purposes. In addition, lenses according to embodiments of the present disclosure may also be useful in improving vision of presbyopes, such as if lens wearers experience issues with decentration of the optic zone, or if they can benefit from targeted improvements in visual acuity for near, intermediate, or far viewing distances. In the case of lenses for use in the management of myopia, a treatment portion may have a characteristic that causes a reduction in contrast of an image that is formed by light passing through the lens, compared to an image that would be formed by light passing through only the central region of the lens. In other words, a treatment portion may cause a reduction in contrast of an image formed by light that has passed through the lens, compared to an image that would be formed by light passing through the same lens without a treatment portion. A treatment portion may comprise contrast-reducing features disposed on a surface of the lens. These features may give rise to additional scattering of light compared to light passing through the remainder of the annular region and the central region. The features may cause light to be diffracted differently compared to light passing through the remainder of the annular region and the central region. A treatment portion may have a curvature that refracts light differently to the remainder of the central region, and thereby causes a contrast reduction of an image formed by light passing through the lens.

Contrast reduction may vary across a treatment portion of each lens. A boundary between a treatment portion and the remainder of an annular may be a sharp boundary, or may be a smooth boundary. There may be a blending zone at the boundary between a treatment portion and the remainder of the annular region. The blending zone may have a characteristic that gives rise to contrast reduction of an image that is formed by light passing through the lens, compared to an image that would be formed by light passing through the central region of the lens. The characteristic may vary and may dissipate in its contrast-reducing effect moving from a treatment portion to an annular region. For example, if a treatment portion has a curvature providing an add power, a blending zone between a treatment portion and the remainder of an annular region may have a gradual change in curvature, and may result in a gradual reduction in add power across the region. If a treatment portion comprises features that increase scattering of light, a blending zone between a treatment portion and the remainder of an annular region may include features that increase scattering, but the density of these features may vary across the blending zone.

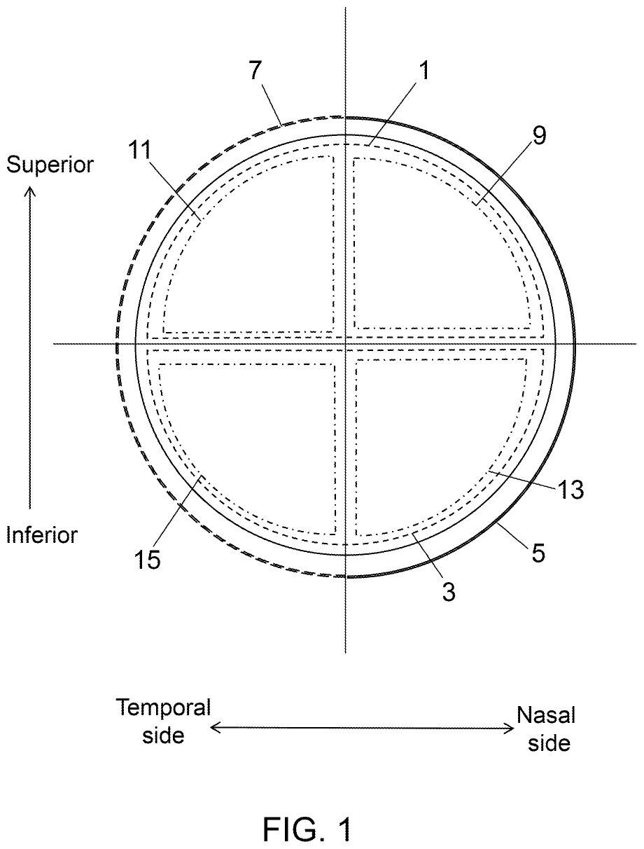

The visual fields of the eye can be divided into quadrants, as shown in FIG. 1, and these quadrants can also be used to describe the quadrants of a contact lens when positioned on an eye. The upper half of the eye/lens is the superior half 1, and the lower half is the inferior half 3. The visual field that is closest to the nose is the nasal half 5, and the visual field that is furthest from the nose is the temporal half 7. Four quadrants can therefore be defined as superior-nasal 9, superior-temporal 11, inferior-nasal 13 and inferior-temporal 15. In the description below, these definitions will be used to describe the position of the add power region and the variation in thickness of the peripheral region as they would be when the lens is in normal use and is being worn by a wearer.

A first optic axis of the centre region may lie along the centreline of the lens. The central region may focus light from a distant point object, on the first optical axis, to a spot on the first optical axis at a distal focal surface. The term surface, as used herein, does not refer to a physical surface, but to a surface that could be drawn through points where light from distant objects would be focused. Such a surface is also referred to as an image plane (even though it can be a curved surface) or image shell. The eye focuses light onto the retina which is curved, and in a perfectly focused eye, the curvature of the image shell would match the curvature of the retina. Therefore the eye does not focus light onto a flat mathematical plane. However, in the art, the curved surface of the retina is commonly referred to as a plane.

A treatment portion may comprise an add power region having a curvature providing an add power that varies with meridian. An anterior surface of a treatment portion may have a smaller radius of curvature than the radius of curvature of the anterior surface of the central region and the remainder of an annular region. A treatment portion may therefore have a greater power than the base power of a central region and the remainder of an annular region. A focal point of a treatment portion may lie on a proximal focal surface, and a focal point for the central region and the remainder of an annular region may lie on a distal focal surface, which is further away from the posterior surface of the lens. A focal point of a treatment portion and the focal point of the central region may share a common optical axis. For a point source at infinity, light rays focused by a central region and an annular region form a focused image at the distal focal surface. Light rays focused by a central region also produce an unfocused blur spot at the proximal focal surface. For each lens, at least some of the add power may be provided by curvature that is centred on a centre of curvature that is a first distance from the first optical axis. Light rays from a distant point source that pass through an add power region may be focused away from the first optical axis on a max add power focal surface. Light rays that pass through a central region will form an on-axis blur circle or ellipse at a max add power focal surface. Light rays from a distant point source that pass through a max add power annular region may be focused outside the blur circle or ellipse. A central region may have the base power. If a treatment portion comprises an add power region, the net near power of the treatment portion will be is the sum of the base power and the add power. The centre of curvature of an add power region may be a first distance from the first optical axis.

A treatment portion may be configured to generate a light distribution at a focal plane of the treatment portion that generally replicates any zonal geometry of the treatment portion. A focal plane of a treatment portion may be defined by a plane that passes through a point at which light passing through the treatment portion is focused. For example, for a treatment portion that spans a portion of an annulus, a focused arc may be generated at the focal plane of the treatment portion. The curvature of a treatment portion can be selected so as to position light that is focused at a treatment portion focal plane at a distance of between about 2 micrometres and about 700 micrometres from and normal to the optic axis, preferably between about 20 micrometres and about 300 micrometres.

A surface of a treatment portion may be an anterior surface. A surface of the central zone may be an anterior surface. A surface of the treatment portion may be the surface that has a curvature providing an add power. A surface of a central region may be the surface that has a curvature providing the base power.

The base power of the lens may be positive, and a treatment portion may have a power that is more positive than the base power. In this case, a max add power focal surface will be closer to the lens than the distal focal surface. An on-axis image will not be formed by light passing through the treatment portion. A wearer of the lens will therefore need to use the natural accommodation of their eye to bring nearby objects into focus. It may be that the light rays focused by a treatment portion do not intersect with the first optical axis of the contact lens at all, or not until after they have passed the max add power focal surface.

The base power of the lens may be negative, and a treatment portion may have a power that is less negative than the power of the base region, or the treatment portion may have a positive power. Considering the lens positioned on the cornea, if the power of a treatment portion is less negative than the base power, a max add power focal surface will be more anterior in the eye than the distal focal surface. Considering the lens when it is not positioned on the cornea, if the power of a treatment portion is positive, a max add power focal surface will be on the opposite (image) side of the lens than the distal focal surface (which will be a virtual focal surface on the object side of the lens); if the power of the treatment portion is negative (but less negative than the base power), a virtual add power focal surface will be further from the lens than a virtual distal focal surface.

When the lens is worn by a user, as the lens is designed to rotate about the optical axis relative to the eye, a treatment portion comprising an add power region may rotate to coincide with different regions of the eye. This is beneficial, particularly for hydrogel and silicone hydrogel contact lenses, as it is believed that over time, the eye may adapt to accommodate blur at the max add power focal surface, thereby reducing the effectiveness of an add power treatment zone preventing the worsening of myopia. Rotating the lens, and thereby rotating an add power region about the optic axis may reduce the ability of the eye to compensate for blur over time. As the lens rotates, different parts of the retina may be exposed to different amounts of defocus, and this may be more effective in slowing the growth of myopia than a lens with a constant myopic defocus.

A treatment portion may comprise an add power region having a curvature providing an add power of 0.5 D or more. An add power region may have a curvature providing a max add-power of at least 2.0 D. A treatment portion may further comprise a lower add power region having a curvature providing a low add-power of between 0 D and 1.5 D. Light rays from a distant point source that pass through the at least one low add power region may be focused at a lower add power focal surface. For a lens that has a positive base power and a lower add power region that has a more positive power than the base power, a lower add power focal surface may be closer to the lens than a distal focal surface but further from the lens than a max add power focal surface. An on-axis image may also not be formed by light passing through a low add power region. It may be that light rays focused by a low add power region do not intersect with the first optical axis of the contact lens at all, or not until after they have passed the lower and max add power focal surfaces. Considering a lens positioned on the cornea, if the lens has a negative base power, and at least one low add power region having a less negative power than the base power, an lower add power focal surface will be closer to the lens than the distal focal surface, but further away than the max add power focal surface. Considering a lens not positioned on the cornea, if the lens has a negative base power and at least one low add power region having a less negative power than the base power, a virtual add power focal surface will be further from the lens than the virtual distal focal surface, but closer than the virtual max add power focal surface. The centre of curvature of an add power region may be a first distance from the first optical axis, and a centre of curvature of a low add power region may be a second distance from the first optical axis.

An annular region may comprise at least one base-power region, having the curvature providing the base power and centred on the centre of curvature of a central region.

Curvatures providing any of the base power, a maximum add power, and a low add power may be curvatures of the anterior surface of the lens. Curvatures providing the base power, a maximum add power, and an intermediate add power may be curvatures of the posterior surface of the lens. Curvatures providing the base power, a maximum add power, and an intermediate add power may be curvatures of the anterior surface and the posterior surface of the lens providing a combined effect.

A treatment portion may include a feature that increases scattering of light passing through the treatment zone compared to light passing through the central region. A feature may be disposed on an anterior surface of the annular region. A treatment portion of each lens may comprise optical elements burned into a surface of the lens, or etched into the surface of the lens. Features that increase scattering of light passing through a treatment portion will reduce the contrast of an image formed from light passing through a treatment zone and a central region, compared to an image that would be formed from light that has only passed through a central region. As the lens rotates relative to the eye about the first optical axis, the treatment zone, and therefore the high scattering region will rotate about the first optic axis. This reduces the ability of the eye to compensate for the reduced contrast caused by the scattering.

A treatment portion may have a characteristic that causes diffraction of light passing through the treatment zone.

The contact lens may be substantially circular in shape and have a diameter from about 4 mm to about 20 mm, preferably between about 13.0 mm and 15.0 mm. As used herein a reference to a diameter is a reference to a chord diameter. The centre thickness of the lens may between about 50 micrometres and about 300 micrometres. The peripheral zone of the lens may have a thickness of between about 50 micrometres and about 450 micrometres. The thickness of the lens can be measured using conventional techniques and instruments such as a Rehder gauge. A central region may be substantially circular in shape and may have diameter of between about 2 and 9 mm, preferably between about, and more preferably between about 2 and 5 mm. A central region may be substantially elliptical in shape. The base curve may have a radius of curvature of between about 8.0 mm and 9.0 mm. An annular region may extend radially outwards from a perimeter of the central region by between about 0.1 to 4 mm, preferably between about 0.5 to 1.5 mm. For example, the radial width of an annular region may be about 0.1 mm to about 4 mm, and preferably may be about 0.5 mm to about 1.5 mm. The perimeter of the central region may define a boundary between the central region and an annular region, and an annular region may therefore be adjacent to the central region.

An annular region of each lens may abut the central region. A blending region may be provided between the central region and an annular region. The blending region should not substantially affect the optics provided by the central region and the annular region, and the blending region may have a radial width of 0.05 mm or less, although it may also be as wide as 0.2 mm, or as wide as 0.5 mm in some embodiments.

An annular region may extend radially outwards to abut the peripheral zone. The treatment portion may span the radial width of the annular zone.

A central region may have a base power, which in the context of the present disclosure, is defined as the average absolute refractive power of the central region. Any base power meridians may also have the base power. The base power will correspond to the labelled refractive power of the contact lens as provided on the contact lens packaging (though in practice it may not have the same value). Thus, the lens powers given herein are nominal powers. These values may differ from lens power values obtained by direct measurement of the lens, and are reflective of the lens powers that are used to provide a required prescription power when used in ophthalmic treatment.

For lenses used in the treatment of myopia, the base power will be negative or close to zero, and the central region will correct for distance vision. The base power may be between 0.5 diopters (D) and −15.0 diopters. The base power may be from −0.25 D to −15.0 D.

The lens may comprise at least two concentric annular regions. Each of the annular regions may comprise a treatment portion that reduces the contrast of an image of an object that is formed by light passing through the central region and the treatment zone compared to an image of an object that would be formed by light passing through only the central region, wherein the contrast reduction varies with meridian around the annular region.

Preferably, any treatment portions do not include lenslets, or are free of lenslets (that is, small lenses provided on a surface of the contact lens that have diameters that are smaller than the diameter of the optic zone of the contact lens).

The peripheral zone of the lens may comprise at least two concentric regions that have a variation in thickness configured to promote rotation of the lens regions. Each concentric region may have the same variation in thickness or a different variation in thickness. Each concentric region may have a periodic variation in thickness, in which case, the variations of adjacent concentric regions may be in phase or out of phase.

The contact lens may be a toric contact lens. For example, the toric contact lens may include an optic zone shaped to correct for a person's astigmatism.

The contact lens may comprise an elastomer material, a silicone elastomer material, a hydrogel material, or a silicone hydrogel material, or combinations thereof. As understood in the field of contact lenses, a hydrogel is a material that retains water in an equilibrium state and is free of a silicone-containing chemical. A silicone hydrogel is a hydrogel that includes a silicone-containing chemical. Hydrogel materials and silicone hydrogel materials, as described in the context of the present disclosure, have an equilibrium water content (EWC) of at least 10% to about 90% (wt/wt). In some embodiments, the hydrogel material or silicone hydrogel material has an EWC from about 30% to about 70% (wt/wt). In comparison, a silicone elastomer material, as described in the context of the present disclosure, has a water content from about 0% to less than 10% (wt/wt). Typically, the silicone elastomer materials used with the present methods or apparatus have a water content from 0.1% to 3% (wt/wt). Examples of suitable lens formulations include those having the following United States Adopted Names (USANs): methafilcon A, ocufilcon A, ocufilcon B, ocufilcon C, ocufilcon D, omafilcon A, omafilcon B, comfilcon A, enfilcon A, stenfilcon A, fanfilcon A, etafilcon A, senofilcon A, senofilcon B, senofilcon C, narafilcon A, narafilcon B, balafilcon A, samfilcon A, lotrafilcon A, lotrafilcon B, somofilcon A, riofilcon A, delefilcon A, verofilcon A, kalifilcon A, lehfilcon A, and the like.

Alternatively, the lens may comprise, consist essentially of, or consist of a silicone elastomer material. For example, the lens may comprise, consist essentially of, or consist of a silicone elastomer material having a Shore A hardness from 3 to 50. The shore A hardness can be determined using conventional methods, as understood by persons of ordinary skill in the art (for example, using a method DIN 53505). Other silicone elastomer materials can be obtained from NuSil Technology or Dow Chemical Company, for example.

According to a second aspect, the present disclosure provides a method of manufacturing a lens. The method may comprise forming a contact lens, wherein the lens includes an optic zone and a peripheral zone surrounding the optic zone. The peripheral zone has a variation in thickness that is configured to promote rotation of the lens.

The lens may include any of the features set out above.

The method of manufacturing may comprise forming a female mold member with a concave lens forming surface and a male mold member with a convex lens forming surface. The method may comprise filling a gap between the female and male mold members with bulk lens material. The method may further comprise curing the bulk lens material to forms the lens.

The contact lens may be a formed using a lathing process. The lens can be formed by cast molding processes, spin cast molding processes, or lathing processes, or a combination thereof. As understood by persons skilled in the art, cast molding refers to the molding of a lens by placing a lens forming material between a female mold member having a concave lens member forming surface, and a male mold member having a convex lens member forming surface.

In a third aspect of the disclosure there is also provided a method of providing a rotationally varying treatment targeted at a region of a lens wearer's retina. The method comprises providing the contact lens described herein to a lens wearer. The methods may be effective in reducing progression of a refractive error, such as reducing the progression of myopia. The methods may be effective in reducing axial length progression. When the present lenses are used to reduce the progression of myopia, the methods include a step of providing the contact lenses to a person whose eyes are able to accommodate for varying near distances (e.g., in a range of from about 15 cm to about 40 cm). The method may be a method of supplying/distributing a medicine or other substance to a lens wearer via the retina. The method may be a method of generating rotationally varying lens features for aesthetic purposes. Some embodiments of the methods include a step of providing the ophthalmic lenses to a person that is from about 5 years old to about 25 years old. The providing can be performed by an eye care practitioner, such as an optician or optometrist. Alternately, the providing can be performed by a lens distributor that arranges for the delivery of the ophthalmic lenses to the lens wearer.

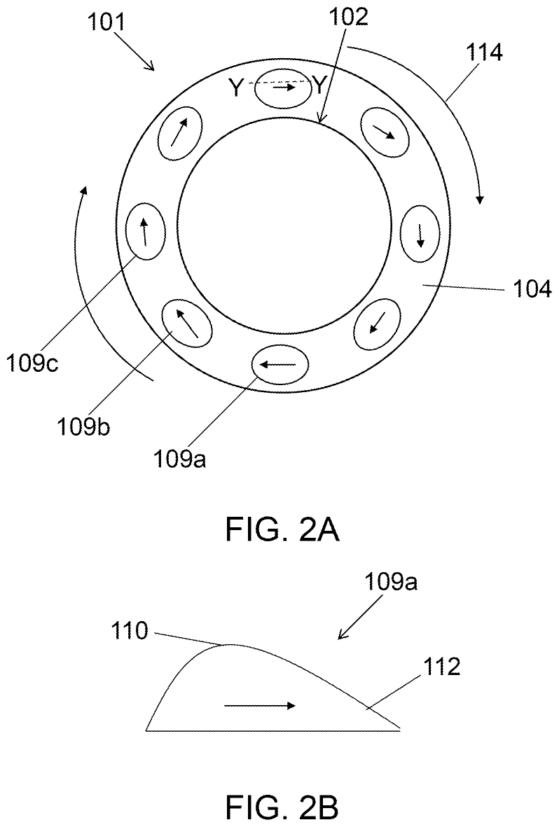

FIG. 2A shows a schematic top view of a lens 101 according to an embodiment of the present disclosure with an optic zone 102. The peripheral zone 104 comprises a plurality of seed-shaped ballasts 109a, 109b, 109c, disposed on the anterior surface of the lens 101 and arranged at regular intervals around the circumference of the lens 101. The ballasts 109a, 109b, 109c, promote rotation of the lens 101, each having a thicker portion 110 and a thinner portion 112 and a smooth, curved upper surface that gives rise to a continually varying thickness, as shown in FIG. 2B. They are arranged around the circumference of the peripheral zone 104 to bias the lens 101 to rotate about the first optical axis in a clockwise direction, as indicated by the arrow 114. If a wearer of the lens 101 blinks, their eyelid will impart a force on the ballasts 109a, 109b, 109c, thereby causing the lens 101 to rotate.

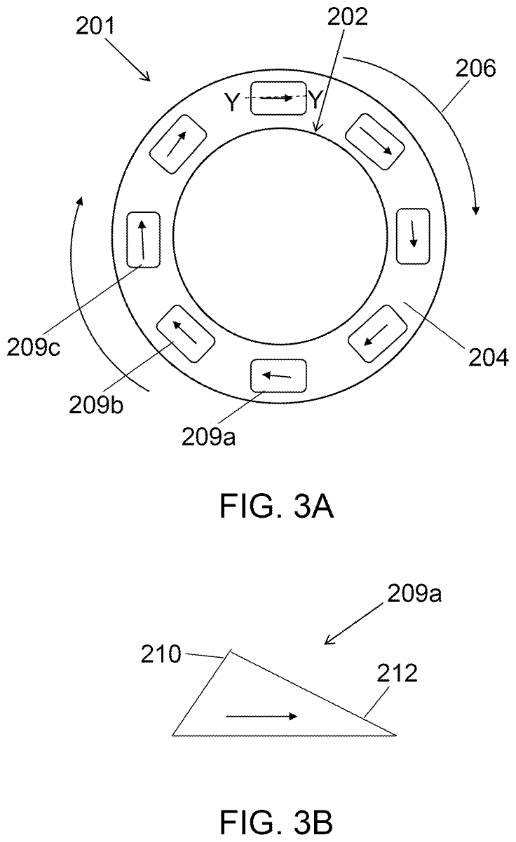

FIG. 3A shows a schematic top view of a lens 201 according to an embodiment of the present disclosure with an optic zone 202. The peripheral zone 204 comprises a plurality of prism-shaped ballasts 209a, 209b, 209c, disposed on the anterior surface of the lens 201, and arranged at regular intervals around the circumference of the lens 201. The ballasts 209a, 209b, 209c promote rotation of the lens 201 in the direction indicated by the arrow 206. Each prism-shaped ballast 209a, 209b, 209c, has a thick portion 210 and a thin portion 212 as shown in FIG. 3B, but in contrast to the seed-shaped ballasts 109a, 109b, 109c of FIGS. 2A and B, the prisms 209a, 209b, 209c comprise flat, straight surfaces, which may aid controlled rotation of the lens 201.

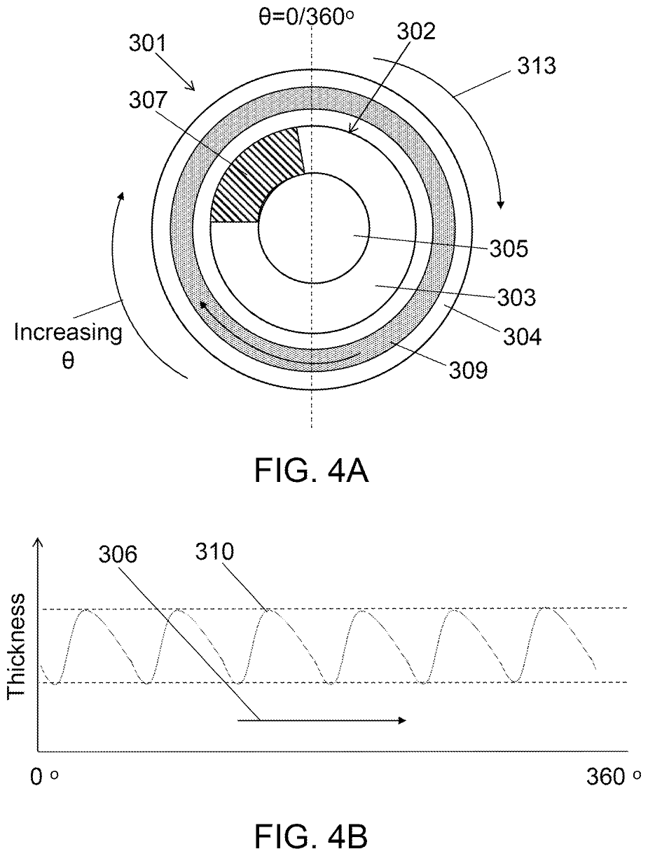

FIG. 4A shows a schematic top view of a lens 301 according to an embodiment of the present disclosure. The optic zone 302 of the lens 301 comprises a central region 305 surrounded by an annular region 303. The annular region 303 comprises a treatment zone 307 that reduces the contrast of an image of an object that is formed by light passing through the central region and the treatment zone compared to an image of an object that would be formed by light passing through only the central region 305. The peripheral zone 304 comprises a continuous band 309 that has a periodically varying thickness profile. The periodically varying thickness profile comprises a plurality of peaks spaced around the circumference of the peripheral zone 304. Defining the position around the circumference of the lens by an angle θ0, where θ varies between 0° and 360° (as shown in FIG. 4A), the continuous band 309 has a peak 310 in thickness every 60°, as shown in FIG. 4B. In order to promote rotation of the lens in the direction indicated by the arrow 313, each peak 310 has an asymmetric profile, which promotes rotation of the lens 301 in the direction indicated by arrow 306 in FIG. 4B.

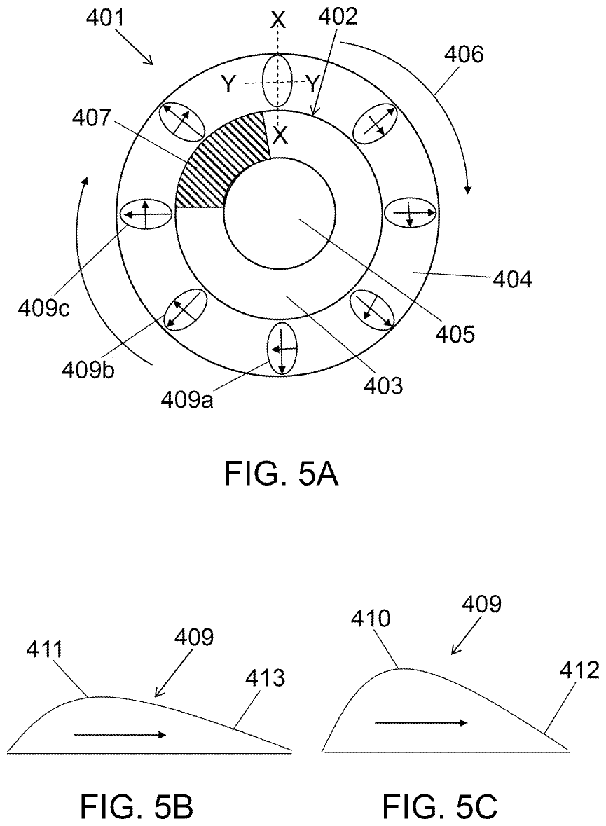

FIG. 5A shows a schematic top view of a lens 401 according to an embodiment of the present disclosure. The optic zone 402 of the lens 401 is similar to the optic zone of the lens shown in FIG. 4A, comprising a central region 405 surrounded by an annular region 403. The annular region 403 comprises a treatment zone 407 that reduces the contrast of an image of an object that is formed by light passing through the central region and the treatment zone compared to an image of an object that would be formed by light passing through only the central region 405. The peripheral zone 404 comprises a plurality of ballasts 409a, 409b, 409c, disposed on the anterior surface of the lens 401 and arranged at regular intervals around the circumference of the lens 401. The ballasts 409a, 409b, 409c are elongated in a radial direction. Similarly to the seed-shaped ballasts of FIG. 2A, each ballast 409a, 409b, 409c has a continually varying thickness profile along the line Y-Y, as shown in FIG. 5C with a thicker portion 410 and a thinner portion 412, and the ballasts (409 in FIGS. 5B and 5C) 409a, 409b, 409c are arranged around the circumference of the peripheral zone 404 to promote rotation of the lens 401 in the direction of the arrow 406. Additionally, each ballast 409a, 409b, 409c, has a varying thickness profile along the line X-X (as shown in FIG. 5B), having a thicker portion 411 towards the centre of the lens 401, and a thinner portion 413 towards the outer edge of the peripheral zone 404.

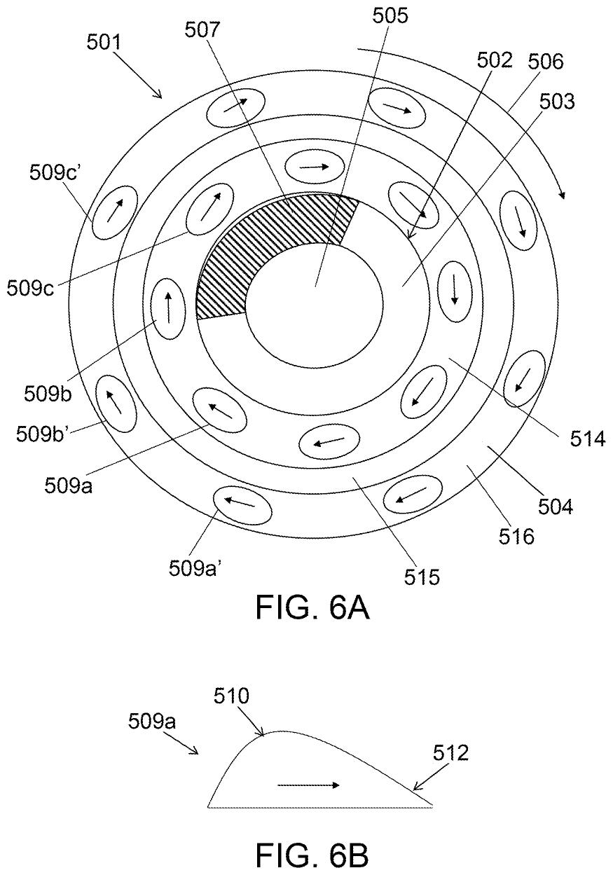

FIG. 6A shows a schematic top view of a lens 501 according to an embodiment of the present disclosure. The optic zone 502 of the lens 501 is similar to the optic zone of the lenses shown in FIGS. 4A-5A, comprising a central region 505 surrounded by an annular region 503. The annular region 503 comprises a treatment zone 507 that reduces the contrast of an image of an object that is formed by light passing through the central region and the treatment zone compared to an image of an object that would be formed by light passing through only the central region 505. The peripheral zone 504 comprises two concentric regions 514, 516, each having a periodically varying thickness profile, separated by a region that has a constant thickness profile 515. Each concentric region 514, 516, comprises a plurality of seed-shaped ballasts 509a, 509b, 509c, 509a′, 509b′, 509c′ disposed on the anterior surface of the lens 501 and arranged at regular around the circumference of the lens 501. These ballasts 509a, 509b, 509c, 509a′, 509bb′, 509c′ promote rotation of the lens 501. The ballasts 509a, 509b, 509c, 509a′, 509b′, 509c′ each have a thicker portion 510 and a thinner portion 512 and a smooth, curved outer surface that gives rise to a continually varying thickness, as shown in FIG. 6B. For each of the concentric regions 514, 516, the ballasts 509a, 509b, 509c, 509a′, 509b′, 509c′ are arranged at regular intervals around the peripheral zone 504, but the ballasts 509a, 509b, 509c of the first region 514 are out of phase with the ballasts 509a′, 509b′, 509c′ of the second region 516. The ballasts 509a, 509b, 509c, 509a′, 509b′, 509c′ bias the lens 501 to rotate about the first optical axis in a clockwise direction, as indicated by the arrow 506. If a wearer of the lens 501 blinks, their eyelid will impart a force on the ballasts 509a, 509b, 509c, 509a′, 509b′, 509c′, thereby causing the lens 501 to rotate.

In other embodiments of the present disclosure, the ballasts disposed on concentric regions of the peripheral zone may be in phase for each of the concentric regions.

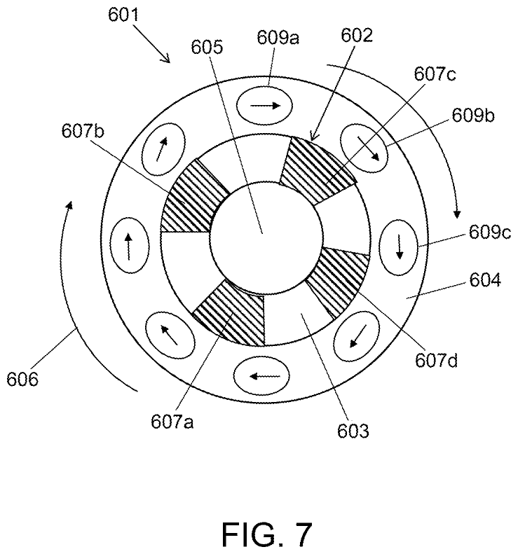

FIG. 7 shows a schematic top view of a lens 601 according to an embodiment of the present disclosure. The optic zone 602 comprises a central region 605 surrounded by an annular region 603. The annular region 603 comprises a plurality of treatment zones 607a, 607b, 607c, 607d, that reduce the contrast of an image of an object that is formed by light passing through the central region and the treatment zone compared to an image of an object that would be formed by light passing through only the central region 605. In between the treatment zones 607a, 607b, 607c, 607d there are regions that do not significantly reduce the contrast of an image formed by light passing through the lens 601. The peripheral zone 604 comprises a plurality of seed-shaped ballasts 609a, 609b, 609c, disposed on the anterior surface of the lens 601 and arranged at regular around the circumference of the lens 601. These ballasts 609a, 609b, 609c, promote rotation of the lens 601 about the first optical axis in a clockwise direction, as indicated by the arrow 606. If a wearer of the lens 601 blinks, their eyelid will impart a force on the ballasts 609a, 609b, 609c, thereby causing the lens 601 to rotate. As the lens 601 rotates about the first optical axis in response to a force, the treatment zones 607a, 607b, 607c, 607d will be brought into coincidence with different regions of the eye. This may reduce the ability of the eye to compensate for the contrast reduction caused by the treatment zones 607a, 607b, 607c, 607d.

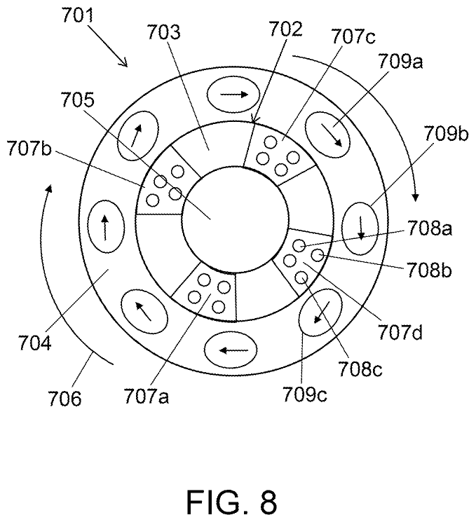

FIG. 8 shows a schematic top view of a lens 701 according to an embodiment of the present disclosure. The optic zone 702 comprises a central region 705 surrounded by an annular region 703. The annular region 703 comprises a plurality of treatment zones 707a, 707b, 707c, 707d, that increase the scattering of light passing through the treatment zones, thereby reducing the contrast of an image of an object that is formed by light passing through the central region and the treatment zone compared to an image of an object that would be formed by light passing through only the central region 705. Each treatment zone 707a, 707b, 707c, 707d comprises a plurality of scattering elements 708a, 708b, 708c which have been burned into the anterior surface of the peripheral zone 704. In between the treatment zones 707a, 707b, 707c, 707d there are regions that do not significantly reduce the contrast of an image formed by light passing through the lens 701. The peripheral zone 704 comprises a plurality of seed-shaped ballasts 709a, 709b, 709c, disposed on the anterior surface of the lens 701 and arranged at regular around the circumference of the lens 701. These ballasts 709a, 709b, 709c, promote rotation of the lens 701 about the first optical axis in a clockwise direction, as indicated by the arrow 706. If a wearer of the lens 701 blinks, their eyelid will impart a force on the ballasts 709a, 709b, 709c, thereby causing the lens 701 to rotate. As the lens 701 rotates about the first optical axis in response to a force, the treatment zones 707a, 707b, 707c, 707d will be brought into coincidence with different regions of the eye. This may reduce the ability of the eye to compensate for the increased scattering of light caused by the treatment zones 707a, 707b, 707c, 707d.

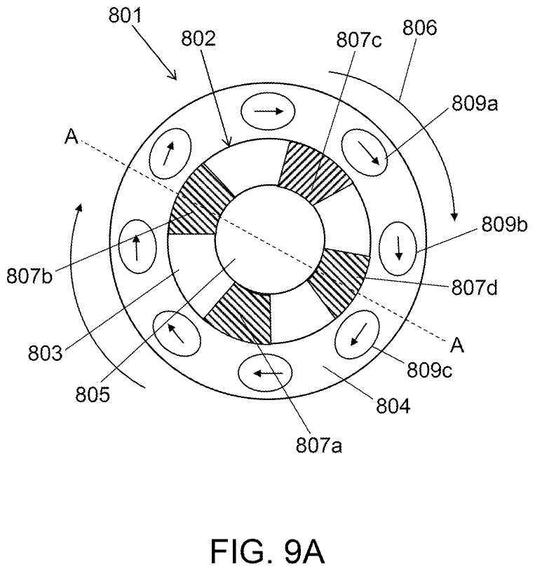

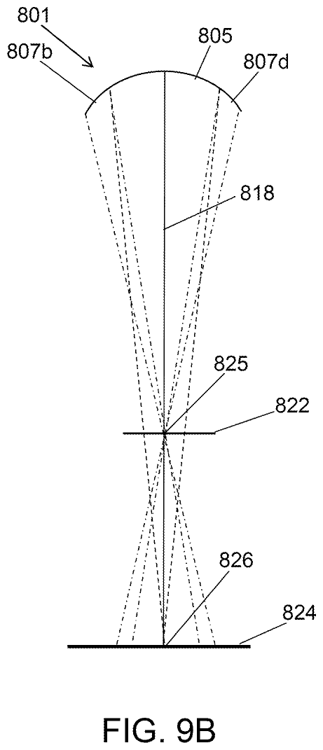

FIG. 9A shows a schematic top view of a lens 801 according to an embodiment of the present disclosure. The optic zone 802 comprises a central region 805 surrounded by an annular region 803. The central region 805 has a curvature providing a base power and centred on a centre of curvature that is on the first optical axis 818. This is shown in FIG. 9B which is a schematic of a cross section through the optic zone of the lens taken along the line A-A.

The annular region 803 comprises a plurality of treatment zones 807a, 807b, 807c, 807d. Each treatment zone 807a, 807b, 807c, 807d has a curvature that provides an add-power. The radius of curvature of the anterior surface of the treatment zones 807a, 807b, 807c, 807d is smaller than the radius of curvature of the anterior surface of the central region 805. The treatment zones 807a, 807b, 807c, 807d therefore have a greater power than the base power of the central region 805. As shown in FIG. 9B, the focal point 825 of the treatment zones 807b, 807d lies on a proximal focal surface 822, and the focal point 826 for the central region 805 lies on a distal focal surface 824, which is further away from the posterior surface of the lens 801. The focal point 825 of the treatment zones 807b, 807d and the focal point 826 of the central region 805 share a common optical axis 818. For a point source at infinity, light rays focused by the central region 805 form a focused image at the distal focal surface 824. Light rays (dash line) focused by the central region 805 also produce an unfocused blur spot at the proximal focal surface 822. Light rays (dot-dashed line) focused by the treatment zones 807b, 807d form a focused image at the proximal focal surface 822. Light rays focused by the treatment zones 807b, 807d diverge after the proximal focal surface 822.

The add-power treatment zones 807a, 807b, 807c, 807d reduce the contrast of an image of an object that is formed by light passing through the central region and the treatment zone compared to an image of an object that would be formed by light passing through only the central region 805. In between the treatment zones 807a, 807b, 807c, 807d there are regions that do not significantly reduce the contrast of an image formed by light passing through the lens 801. The peripheral zone 804 comprises a plurality of seed-shaped ballasts 809a, 809b, 809c, disposed on the anterior surface of the lens 801 and arranged at regular around the circumference of the lens 801. These ballasts 809a, 809b, 809c, promote rotation of the lens 801 about the first optical axis in a clockwise direction, as indicated by the arrow 806. If a wearer of the lens 801 blinks, their eyelid will impart a force on the ballasts 809a, 809b, 809c, thereby causing the lens 801 to rotate. As the lens 801 rotates about the first optical axis in response to a force, the treatment zones 807a, 807b, 807c, 807d will be bought into coincidence with different regions of the eye. This may reduce the ability of the eye to compensate for the defocusing effect of the treatment zones 807a, 807b, 807c, 807d.

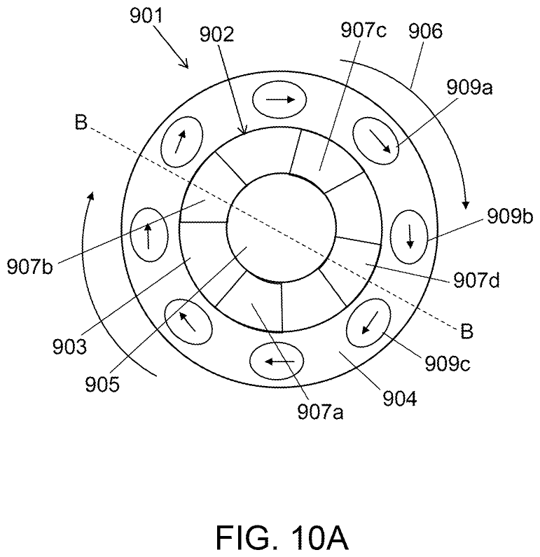

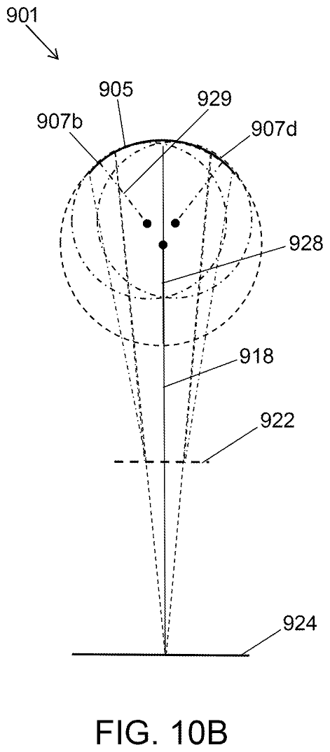

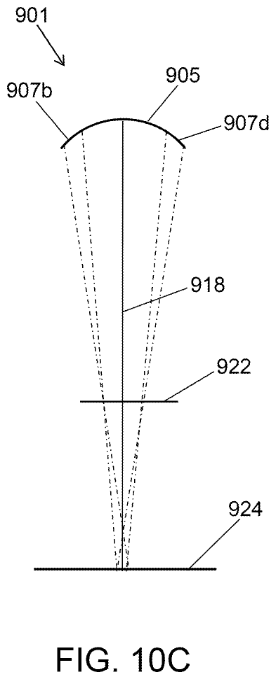

FIG. 10A shows a schematic top view of a lens 901 according to an embodiment of the present disclosure. The optic zone 902 comprises a central region 905 surrounded by an annular region 903. The central region 905 has a curvature providing a base power and centred on a centre of curvature that is on the first optical axis 918. This is shown in FIG. 10B which is a schematic of a cross section through the lens taken along the line B-B.

The annular region 903 comprises a plurality of treatment zones 907a, 907b, 907c, 907d. Each treatment zone 907a, 907b, 907c, 907d has a curvature that provides an add-power. The radius of curvature of the anterior surface of the treatment zones 907a, 907b, 907c, 907d (indicated by the dashed circles) is smaller than the radius of curvature of the anterior surface of the central region 905. The treatment zones 907a, 907b, 907c, 907d therefore have a greater power than the base power of the central region 905. As shown in FIG. 10B, the anterior surface of the central region 905 defines a portion of a surface of a sphere of radius 928 (indicated by the dashed circle). The anterior surface of the treatment zones 907b, 907d defines a curved annular surface with radius of curvature 929.

As shown in FIGS. 10B and 10C, at the distal focal surface 924, light rays (dash lines) passing through the central region 905 are focused. A single image is not formed at the proximal focal surface 922. At the proximal focal surface 922, for a point source at infinity, light rays (dashed lines) passing through the central region 905 generate a blur circle. However, light rays (dot-dashed lines) from a distant point source passing through the treatment zones 907b, 907d, generate focused arcs which surround the blur circle.

The add-power treatment zones 907a, 907b, 907c, 907d reduce the contrast of an image of an object that is formed by light passing through the central region and the treatment zone compared to an image of an object that would be formed by light passing through only the central region 905. In between the treatment zones 907a, 907b, 907c, 907d there are regions that do not significantly reduce the contrast of an image formed by light passing through the lens 901. The peripheral zone 904 comprises a plurality of seed-shaped ballasts 909a, 909b, 909c, disposed on the anterior surface of the lens 901 and arranged at regular intervals around the circumference of the lens 901. These ballasts 909a, 909b, 909c, promote rotation of the lens 901 about the first optical axis in a clockwise direction, as indicated by the arrow 906. If a wearer of the lens 901 blinks, their eyelid will impart a force on the ballasts 909a, 909b, 909c, thereby causing the lens 901 to rotate. As the lens 901 rotates about the first optical axis in response to a force, the treatment zones 907a, 907b, 907c, 907d will be brought into coincidence with different regions of the eye. This may reduce the ability of the eye to compensate for the defocusing effect of the treatment zones 907a, 907b, 907c, 907d.

Whilst in the foregoing description, integers or elements are mentioned which have known obvious or foreseeable equivalents, then such equivalents are herein incorporated as if individually set forth. Reference should be made to the claims for determining the true scope of the present disclosure, which should be construed as to encompass any such equivalents. It will also be appreciated by the reader that integers or features of the disclosure that are described as advantageous, convenient or the like are optional, and do not limit the scope of the independent claims. Moreover, it is to be understood that such optional integers or features, whilst of possible benefit in some embodiments of the disclosure, may not be desirable and may therefore be absent in other embodiments.

1. A contact lens comprising: an optic zone and a peripheral zone surrounding the optic zone, wherein the peripheral zone has a variation in thickness configured to promote rotation of the lens.

2. The contact lens according to claim 1, wherein the thickness profile of the peripheral zone has no axis of mirror symmetry.

3. The contact lens according to claim 1 wherein the thickness of the peripheral zone is constant on one half of the lens and varies on the other half of the lens.

4. The contact lens according to claim 3, in which the variation on the other half of the lens provides a prism ballast on that half of the lens.

5. The contact lens according to claim 1, and wherein the thickness of the peripheral zone varies periodically around the lens.

6. The contact lens according to claim 5, in which the periodic variation is a sinusoid waveform, a triangular waveform, or a sawtooth waveform.

7. The contact lens according to claim 1, wherein the thickness profile variation results from features disposed on a surface of the peripheral zone.

8. The contact lens according to claim 1, wherein the lens is substantially circular in shape and has a diameter from about 4 mm to about 20 mm.

9. The contact lens according to claim 1, wherein the optic zone of the lens has a base power of between 0.5 and −15.0 D.

10. The contact lens according to claim 1, wherein the optic zone includes a central region and an annular region that surrounds the central region, and wherein the annular region comprises a treatment portion that varies with meridian.

11. The contact lens according to claim 10, wherein the treatment portion spans less than 50% of the area of the annular region.

12. The contact lens according to claim 9, wherein the treatment portion has a characteristic that causes a reduction in contrast of an image that is formed by light passing through the lens, compared to an image that would be formed by light passing through only the central region of the lens.

13. The contact lens according to claim 9, wherein the treatment portion comprises an add power region having a curvature providing an add power that varies with meridian.

14. The contact lens according to claim 9, wherein the treatment portion includes a feature that increases scattering of light passing through the treatment zone compared to light passing through the central region.

15. The contact lens according to claim 9, wherein the treatment portion has a characteristic that causes diffraction of light passing through the treatment zone.

16. The contact lens according to claim 1, wherein the lens comprises an elastomer material, a silicone elastomer material, a hydrogel material, or a silicone hydrogel material, or combinations thereof.

17. The contact lens according to claim 1, wherein the lens is formed using a cast-molding process.

18. A method of manufacturing a contact lens, the method comprising:
forming a contact lens, the lens including an optic zone and a peripheral zone surrounding the optic zone, the peripheral zone having a variation in thickness that is configured to promote rotation of the lens.

19. A method of providing rotationally varying treatment targeted at a region of a lens wearer's retina, comprising:
providing a contact lens according to claim 1 to a lens wearer.

20. The method according to claim 19, wherein the treatment is a treatment for reducing the progression of myopia, and wherein the method comprises providing a contact lens according to a myopic person who is able to accommodate for varying near distances.
